(19) United States
(12) Patent Application Publication
(10) Pub. No.: US 2001/0010038 A1
(43) Pub. Date: Jul. 26, 2001

(54) High-speed search method for LSP quantizer using split VQ and fixed codebook of G.729 speech encoder

(76) Inventors: Sang Won Kang, Anyang (KR); Chang Yong Son, Seoul (KR); Won Il Lee, Seong Nam (KR); Yoo Na Sung, Seoul (KR); Min Kyu Shim, Seoul (KR); Seong Hoon Hong, Seoul (KR)

Correspondence Address: BACON & THOMAS, PLLC, 4th Floor, 625 Slaters Lane, Alexandria, VA, 22314-1176, US

(21) Appl. No.: 09/749,782

(22) Filed: Dec. 28, 2000

(30) Foreign Application Priority Data
Jan. 14, 2000 (KR) 1756
Feb. 25, 2000 (KR) 9519
Apr. 11, 2000 (KR) 18838

(51) Int. Cl. G10L 19/12; G10L 21/00

(52) U.S. Cl. 704/222

(57) ABSTRACT

A high-speed search method in a speech encoder using an order character of LSP (Line Spectrum Pair) counts in a LSP count quantizer using SVQ (Split Vector Quantization) used in a low-speed transmission speech encoder, includes the steps of rearranging a codebook according to an element value of a reference row for determining a range of code vectors to be searched; and determining a search range by using an order character between a given target vector and an arranged code vector to obtain an optimal code vector.

The method gives effects of reducing computational complex required to search the codebook without signal distortion in quantizing the LSP counts of the speech encoder using SVQ manner, and reducing computational complex without loss of tone quality in G.729 fixed codebook search by performing candidate selection and search on the basis of the correlation value size of the pulse position index.

### BACKGROUND OF THE INVENTION

1. Technical field

The present invention relates to a high-speed search method for a LSP (Local Spectrum Pair) using SVQ (Split Vector Quantization) and a fixed codebook of the G.729 speech encoder, and more particularly to a high-speed search method which may decrease overall computational complexity without sacrificing spectral distortion performance by reducing a size of the codebook using an order character of LSP counts in searching a codebook having high computational complexity during quantizing a split vector of LSP counts of a speech encoder, used to compress voice signals in a low speed, and a high-speed search method which may dramatically reduce computational complexity without loss of tone quality by detecting and searching tracks on the basis of a magnitude order of a correlation signal (d′(n)), obtained by a impulse response and a target signal in the process of searching the fixed codebook of the G.729 speech encoder.

2. Description of the Prior Art

Generally, for the speech encoding in a less than 16kbps transmission rate, the speech is not directly transmitted but parameters representing the speech are sampled and quantized to reduce magnitude of the data, in a circumstance that the bandwidth is limited.

For high-quality encoding, the low transmission speech encoder quanitizes LPC counts, in which an optimal LPC count is obtained by dividing the input speech signal in a frame unit to minimize predictive error energy in each frame.

LPC filter is commonly a 10^{th} ALL-POLE filter.

In the above conventional method, more bits should be assigned to quantize the 10 LPC counts. However, when directly quantizing the LPC counts, there are problems that characters of the filters are very sensitive to the quantization error and that stability of the LPC filter is not assured after quantizing the counts.

### SUMMARY OF THE INVENTION

Therefore, the present invention is designed to overcome the problems of the prior art. An object of the present invention is to provide

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a block diagram for illustrating a general SVQ (Split Vector Quantization);

FIG. 2 is a flowchart for illustrating how to determining a code vector in a LSP (Line Spectrum Pair) quantizer used in a low transmission speech encoder according to the present invention;

FIG. 3 shows a high-speed search method in a LSP quantizer according to the present invention;

FIGS. 4a and 4b show a start point and an end point of a code vector group satisfying the order character, in which FIG. 4a and FIG. 4b shows a forward comparison and a backward comparison, respectively; and

FIG. 5 shows a fixed codebook search method according to the present invention.

### DETAILED DESCRIPTION OF THE PREFERRED EMBODIMENT

Hereinafter, preferred embodiments of the present invention will be described in detail with reference to the accompanying drawings.

Quantizing overall vectors at one time is substantially impossible because a size of the vector table becomes too big and too much time is taken for search. To solve this problem, the present invention employs SVQ (Split Vector Quantization) to divide overall vectors into several sub-vectors and then quantize the sub-vectors independently. A predictive SVQ, which is a method adding a prediction unit to the SVQ, uses correlation between frames of the LSP (Linear Spectrum Pair) counts for more efficient quantization. That is, the predictive SVQ does not quantize the LSP of a current frame directly, but predict the LSP of the current frame on the basis of a LSP of the previous frame and then quantize a prediction error. The LSP has a close relation with a frequency character of the speech signal, so making time prediction possible with great gains.

When quantizing the LSP counts with such VQ, most of quantizers have a great amount of LSP codebook. And, in order to reduce computational complexity in searching an optimal code vector in the codebook, the quantizer decreases a range of codes to be searched by using an order of the LSP counts. That is, the quantizer arranges the code vectors in the codebook for a target vector in a descending order according to element values in a specific row in a sub-vector. Then, the optimal code vector, which minimizes distortion in the arranged codebook, has nearly identical value with that of the target vector, which implies that such value has an order character. Under such presumption, the present invention compares an element value of a specific row arranged in a descending order with element values of other adjacent rows and then calculates distortion with high computational complexity for the code vectors, which satisfies the order character, and cancels the calculation process for other code vectors.

Such method may reduce a great amount of computational complexity, overall.

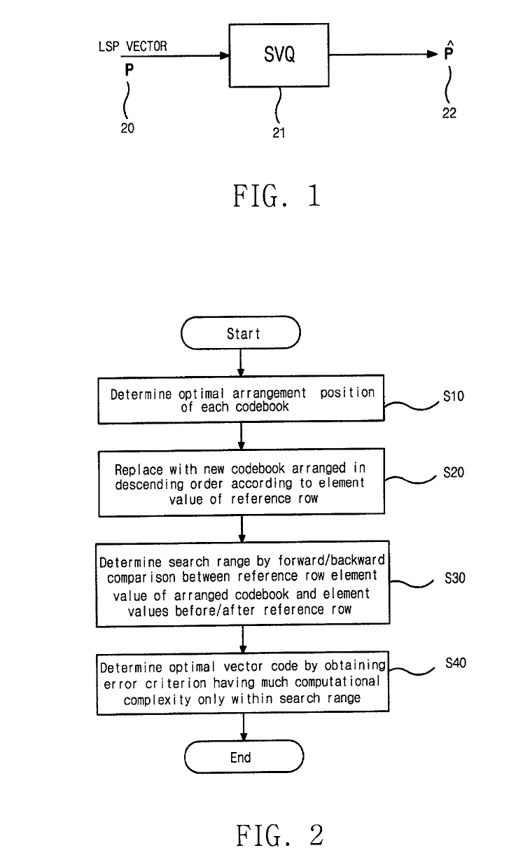

FIG. 1 shows a structure of a general SVQ. As shown in the figure, the target vector, or LSP vector (p) satisfies the below order character.

O<p₁<p₂<. . . <pₚ<π [Equation 1]

$${{( {E}_{1 , m} = {( {p}_{m} - p \}}_{1 , m} ) )}^{T} {W}_{m} ( {p}_{m} - p \}}_{1 , m} ) \\ 0 \leq m \leq M - 1 \\ 1 \leq l \leq {L}_{m} \qquad \text{[Equation 2]}$$

In the Equation 2, the error criterion Elm is represented as a formula of p and p}, in which pₘ is a target vector to search the m^{th} codebook, and p}_{1,m} is corresponding to a ∫^{th} code vector in a codebook for m^{th} sub-vector. Here, an optimal code vector for each sub-vector is selected to minimize the next error criterion E_{1,m} and then transmitted through a finally selected codebook index (∫)

In the Equation 2, the LSP code vector (p}) is divided into M number of sub-vectors, each of which consists of Lₘ number of code vectors. Codebook magnitudes (L₀, L₁, . . . , L_{M-1}) of M number of the sub-vectors may use same bit, but preferably, an additional bit may be assigned to a specific sub-vector to improve tone quality. Wₘ is a weighting matrix for the m^{th} sub-vector and obtained by a non-quanitized LSF vector (p).

In order to employ a high-speed search method in the present invention, conversion of the conventional codebook is needed. This is a process of replacing the conventional codebook with a new codebook, which is arranged in a descending order on the basis of a specific row (or, reference row), experimentally determined. The reference row is selected for each codebook and should be a row in which an average search range is minimized experimentally. The average search range is an average number with which an element value of the n^{th} row in the arranged codebook based on each nth row and an element value of n+1^{th} and n−1^{th} positions in the target vector satisfy the order character with use of the target vector for the arranged codebook.

$$\begin{matrix}{( {( p \} )}_{1 , n} > p \} )}_{n - 1} , & 1 \leq l \leq L & 0 \leq n \leq 8 \\ {( {( p \} )}_{1 , n} > p \} )}_{n + 1} , & 1 \leq l \leq L , & 1 \leq n \leq 9\end{matrix} \qquad \text{[Equation 3]}$$

As seen in the Equation 3, the element value of the n−1^{th} row in the target vector should be less than the element value of the n^{th} row in the codebook, while the element value of the n+1^{th} row should be bigger than the element value of the nth row in the codebook.

Presuming that the reference row of each codebook, which is optimized to each codebook, is N₀, N₁, . . . , Nₘ and the 10^{th} LSP vector is a target vector, a search range of the codebook is determined by comparing the element value of the reference row in the codebook to be searched using the following Equations 4 and 5 with element values of rows before and after the reference row in the target vector and then excluding code vectors, which are not satisfying the order character, from the searching process.

$$\begin{matrix}{{p}_{N - 1} > p \}}_{1 , N} , & 1 \leq l \leq L , & 1 \leq N \leq 9\end{matrix} \qquad \text{[Equation 4]}$$

$$\begin{matrix}{{p}_{N + 1} > p \}}_{1 , N} , & 1 \leq l \leq L , & 0 \leq N \leq 8\end{matrix} \qquad \text{[Equation 5]}$$

In this specification, comparing an element value of N^{th} row of a code vector with an element value of a N−1^{th} row of a target vector as shown in the Equation 4 to determining whether they satisfy the order character is called as a forward comparison, comparing the element value of the N^{th} row of the code vector with an element value of a N+1^{th} row of the target vector as shown in the Equation 5 to determining whether they satisfy the order character is called as a backward comparison.

Hereinafter, preferred embodiments of the present invention are explained with reference to the accompanying drawings.

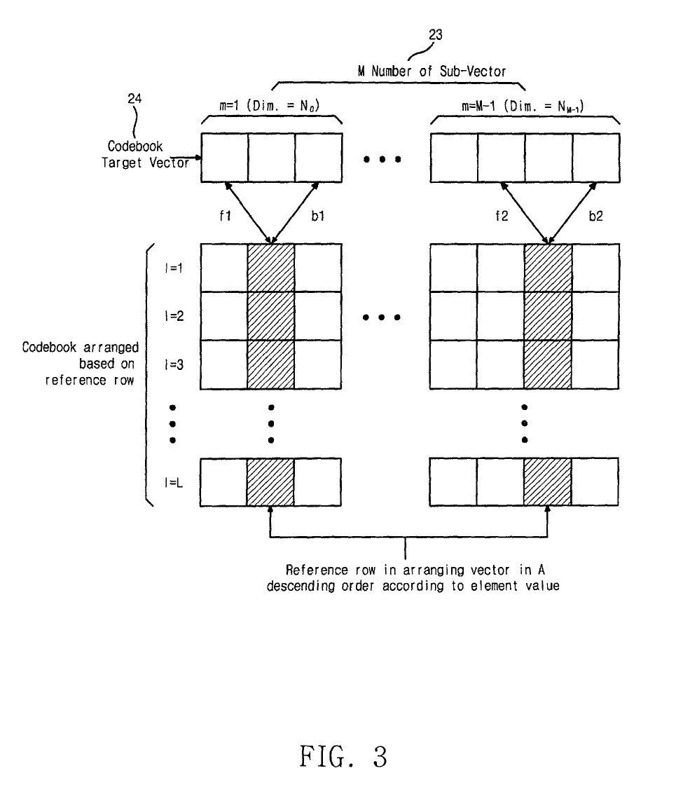

FIG. 2 is a flowchart for illustrating the process of determining a code vector in the LSP quantizer, used in the low transmission speech encoder, according to the present invention. As shown in the figure, the process includes the steps of experimentally determining an optimal arrangement position for each codebook by using various speech data S10 replacing the codebook, in which a predetermined number of code vectors are arranged, with a new codebook, which is arranged in a descending order according to an element value of a determined reference row S20, determining a search range by forward and backward comparison of the element value of the arranged codebook and element values before and after a corresponding row of the target vector according to a predetermined flowchart S30, and determining an optimal code vector by obtaining an error criterion only within the predetermined search range S40.

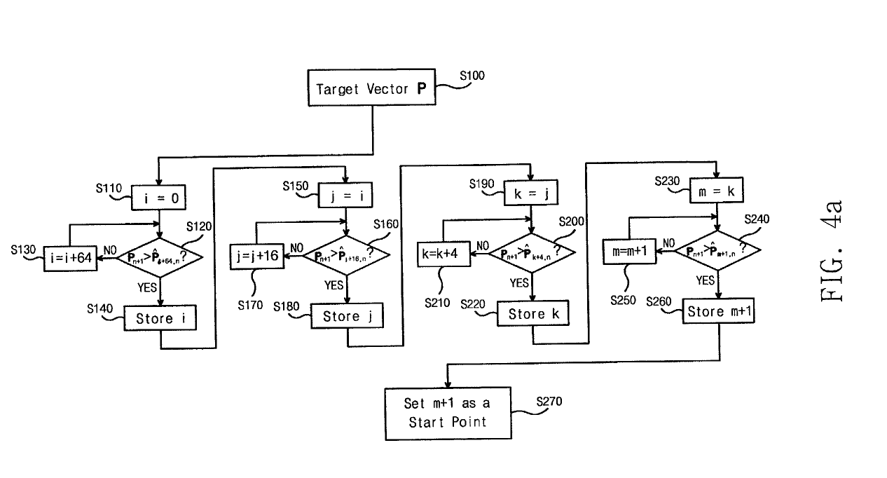

FIG. 3 shows a high-speed search method in the LSP quantizer according to the present invention. As shown in the figure, f1, f2 and b1, b2 indicate element values of the code vector and the target vector used in the forward and backward comparison, respectively. Here, because each codebook is arranged in a descending order, if obtaining a start point satisfying the order character in the forward comparison, other element values become automatically satisfying the forward order character. In the backward comparison, what is only have to do is to obtain an end point, which satisfies the order character.

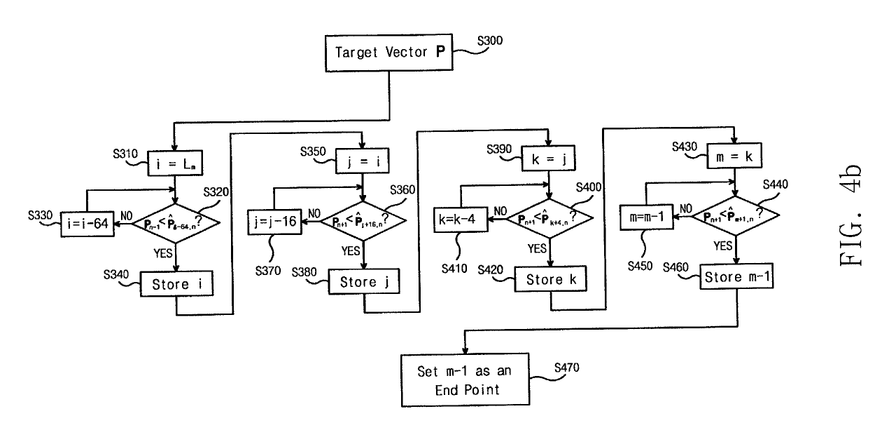

The process of obtaining a substantial start point and an end point of a code vector group, satisfying the order character for the given target vector, is shown in FIG. 4.

FIGS. 4a and 4b are flowcharts for illustrating the process of obtaining a substantial start point and an end point of a code vector group, which satisfies the order character, for the forward and backward comparison, respectively. The search range of the codebook can be calculated with the start point and the end point, obtained by such flowcharts.

As shown in FIG. 4a, the process of obtaining a codebook search start point includes the steps of calculating a LSP vector (p) S100, initializing a variable i into 0 (zero) S110, comparing a size of pₙ₊₁ with a size of p}_{i+64,n} S120, increasing the variable i as much as 64 if the size of pₙ₊₁ is smaller than the size of p}_{i+64,n} S130, storing the variable i if the size of pₙ₊₁ is bigger than the size of p}_{i+64, n} S140, initializing a variable j into the stored variable i S150, comparing a size of pₙ₊₁ with a size of p}_{j+16,n} S160, increase the variable j as much as 16 if the size of pₙ₊₁ is smaller than the size of p}_{j+16,n} S170, storing the variable j if the size of pₙ₊₁ is bigger than the size of p}_{j+16,n} S180, initializing a variable k into the stored variable j S190, comparing a size of pₙ₊₁ with a size of p}_{k+4,n} S200, increasing the variable k as much as 4 if the size of pₙ₊₁ is smaller than the size of p}_{k+4,n} S210, storing the variable k if the size of pₙ₊₁ is bigger than the size of p}_{k+4,n} S220, initializing a variable m into the stored variable k S230, comparing a size of pₙ₊₁ with a size of p}_{m+1,n} S240, increasing the variable m as much as 1 if the size of pₙ₊₁ is smaller than the size of p}_{m+1,n} S250, storing the variable m+1 if the size of pₙ₊₁ is bigger than the size of p}_{m+1, n} S260, and setting the calculated variable m+1 as a start point S270.

As shown in FIG. 4b, the process of setting a codebook search end point includes the steps of calculating the LSP vector (p) S300, initializing a variable i into Lₘ S310, comparing a size of pₙ₋₁ with a size of P}_{i-64, n} S320, decreasing the variable i as much as 64 if the size of pₙ₋₁ is bigger than the size of p}_{i-64, n} S330, storing the variable i if the size of pₙ₋₁ is smaller than the size of p}_{i-64, n} S340, initializing a variable j into the stored variable i S350, comparing the size of pₙ₋ᵢ with a size of p}_{j-16, n} S360, decreasing the variable j as much as 16 if the size of pₙ₋ᵢ is bigger than the size of p}_{j-16, n} S370, storing the variable j if the size of Pₙ₋ᵢ is smaller than the size of p}_{j-16,n} S380, initializing a variable k into the stored variable j S390, comparing the size of pₙ₋ᵢ with a size of P}_{k-4, n} S400, decreasing the variable k as much as 4 if the size of pₙ₋₁ is bigger than the size of p}_{k-4, n} S410, storing the variable k if the size of pₙ₋₁ is smaller than the size of P}_{k-4, n} S420, initializing a variable m into the stored variable k S430, comparing the size of pₙ₋₁ with a size of p}_{m-1, n} S440, decreasing the variable m as much as 1 if the size of pₙ₋₁ is bigger than the size of p}_{m-1, n} S450, storing the variable m−1 if the size of pₙ₋₁ is smaller than the size of p}_{m-1, n} S460, and then setting the calculated variable m−1 as an end point S470.

If the start point and the end point are calculated, an optimally quantized vector may be selected by obtaining a distortion only for the vectors within the range between the start point and the end point.

An efficient search method of the fixed codebook is very important for high quality speech encoding in a low-transmission speech encoder. In the G.729, the fixed codebook is searched for each sub-frame, and 17-bit logarithmic codebook is used for the fixed codebook, and an index of the searched codebook is transmitted. A Vector in each fixed codebook has 4 pulses with a size of +1 or −1 in a designated position as shown in Table 1 and is represented like the Formula 6.

$$c ( n ) = {\sum }_{i = 0}^{3} {s}_{i} δ ( n - {m}_{i} ) n = 0 , 1 , … , 39 \qquad \text{[Equation 6]}$$

in which c(n) is a fixed codebook vector and δ(n) is a unit pulse.

An object signal x′(n) for search in the fixed codebook is obtained by eliminating a portion contributed by an adaptable codebook in an object signal x(n) used in a pitch search and may be represented like the following Formula 7.

$${x}^{′} ( n ) = x ( n ) - {g}_{p} y ( n ) n = 0 , 1 , … , 39 \qquad \text{[Equation 7]}$$

in which gₚ is a gain of the adaptable codebook, and y(n) is a vector of the adaptable codebook.

Assuming that a codebook vector of an index (k) is cₖ, an optical code vector is selected as a codebook vector, which maximizes the following Formula 8.

$${T}_{k} = \frac{{C}_{k}^{2}}{{E}_{k}} = \frac{{( {d}^{t} {c}_{k} )}^{2}}{{c}_{k}^{t} Φ {c}_{k}} \qquad \text{[Equation 8]}$$

in which d is a correlation vector between the object signal x′(n) and an impulse response h(n) of a composite filter, and Φ is a correlation matrix with h(n). That is, d and Φ are represented with the following Formulas 9 and 10.

$$d ( n ) = {\sum }_{t = n}^{39} {x}^{′} ( i ) h ( i - n ) i = 0 , 1 , … , 39 \qquad \text{[Equation 9]}$$

$$Φ ( i , j ) = {\sum }_{n = j}^{39} h ( n - i ) h ( n - j ) \\ i = 0 , 1 , … 39 ; j = i , … 39 \qquad \text{[Equation 10]}$$

The codebook search is comprised of 4 loops, each of which determines a new pulse. The numerator in the Formula 8 is given as the following Formula 11, and the denominator in the Formula 8 is given as the following Formula 12.

$$C = {\sum }_{i = 0}^{3} {s}_{i} d ( {m}_{i} ) \qquad \text{[Equation 11]}$$

in which mᵢ is a position of i^{th} pulse, and sᵢ is its sign

$$E = {\sum }_{i = 0}^{3} φ ( {m}_{i} , {m}_{j} ) + 2 {\sum }_{i = 0}^{2} {\sum }_{j = i + 1}^{3} {s}_{i} , {s}_{j} φ ( {m}_{i} , {m}_{j} ) \qquad \text{[Equation 12]}$$

In order to reduce the computational complexity in the codebook search, the following process is employed. At first, d(n) is decomposed into an absolute value d′(n)=|d(n) | and its sign. At this time, the sign value is previously determined for available 40 pulses in Table 1. And, the matrix Φ is modified into φ′(i,j)=sign[s(i)] sign[s(j)] φ(i,j), φ′(i,j)=0.5φ(i,j) in order to include the previously obtained sign value. Therefore, the Formula 11 may be represented as:

C=d′(m₀)+d′(m₁)+d′(m₂)+d′(m₃)

and the Formula 12 may be represented as:

$$\begin{matrix}\frac{E}{2} = {φ}^{′} ( {m}_{0} , {m}_{0} ) + {φ}^{′} ( {m}_{1} , {m}_{1} ) + {φ}^{′} ( {m}_{2} , {m}_{2} ) + \\ {φ}^{′} ( {m}_{0} , {m}_{1} ) + {φ}^{′} ( {m}_{0} , {m}_{2} ) + {φ}^{′} ( {m}_{0} , {m}_{3} ) + \\ {φ}^{′} ( {m}_{1} , {m}_{2} ) + {φ}^{′} ( {m}_{1} , {m}_{3} ) + {φ}^{′} ( {m}_{2} , {m}_{3} )\end{matrix}$$

In order to search all available pulse positions, 2¹³ (=8,192) compositions should be searched. However, in order to reduce computational complexity, a threshold value (Cₜₕ) is determined as a candidate for searching 16 available pulses in a final track (t₃) and then a part of candidates having low possibility are excluded on the basis of experimental data among all of 2⁹ (=512) compositions to search pulses in the track (t₃) only for the candidates which are over the threshold value.

At this time, the threshold value (Cₜₕ) is determined with a function of a maximum correlation value and an average correlation value of the prior three tracks (t₀, t₁, t₂). The maximum correlation value of the tracks (t₀, t₁, t₂) can be expressed as the following Formula 13. pg,16

Cₘₐₓ=max[d′(t₀)]+max[d′(t₁)]+max[d′(t₂)] [Equation 13]

in which max[d′(tᵢ)] is a maximum value of d′(n) in the three tracks (t₀, t₁, t₂). And, the average correlation value based on the tracks (t₀, t₁, t₂) is as follows.

$${C}_{av} = \frac{1}{8} [ {\sum }_{n = 0}^{7} {d}^{′} ( 5 n ) + {\sum }_{n = 0}^{7} {d}^{′} ( 5 n + 1 ) + {\sum }_{n = 0}^{7} {d}^{′} ( 5 n + 2 ) ] \qquad \text{[Equation 14]}$$

Here, the threshold value is given as the following Formula 15.

Cₜₕ Cₐᵥ+(Cₘₐₓ−Cₐᵥ)αₜ [Equation 15]

The threshold value is determined before searching the fixed codebook. And, candidates only over the threshold value are subject to search of the final track (t₃). Here, the value of αₜ is used to control the number of candidates to search the final track (t3), in which the number of all candidates (N=512) becomes average N=60, and only 5% are over N=90. In addition, the track (t₃) is limited to N₁=105, and the number of the maximum candidates is limited to 180−N₁. At this time, among 8, 192 compositions, 90×16=1440 number of searches are accomplished.

When searching the fixed codebook in the above process, most of computations are required in searching a position of the optimal pulse in a loop of each track. Therefore, the high-speed search method of the present invention arranges values of each d′(n) in the tracks (t₀, t₁, t₂) and then searches an index which has the biggest d′(n) value among the three loops. The Tables 2 and 3 show such examples, which follows the below methods.

At first, the position indexes of the tracks (t₀, t₁, t₂) are arranged in a descending order according to the d′(n) value. As seen in the Table 4, a position index that has the biggest probability to be an optimal pulse position, is searched first. Because the numerator of the Formula 8 based on the d′(n) value is in a square type, its attribution is more than that of the denominator. A pulse position, which maximizes the correlation value (Ck), has great possibilities to be an optimal pulse position. This can be easily understood with the Table 4, which statistically shows probability to be selected as an optimal position for each pulse in the fixed codebook, arranged in a descending order according to the d′(n) value. In other words, a pulse position having the biggest d′(n) value is most probably an optimal pulse position.

Then, because the threshold value in the Formula 17 is composed of only the d′(n) values of the tracks (t₀, t₁, t₂) and arranged with the d′(n) values in a descending order, after calculating each d′(n) value of the tracks (t₀, t₁, t₂) and then determining whether their sum is over the predetermined threshold value, the search process is executed if the sum is over the threshold value but the codebook search is finished if the sum is not over the threshold value.

As described above, the candidate values over the threshold may be searched in a high-speed by sequentially arranging the fixed codebook according to the d′(n) values and calculating the correlation value Ck on the basis of the arranged codebook.

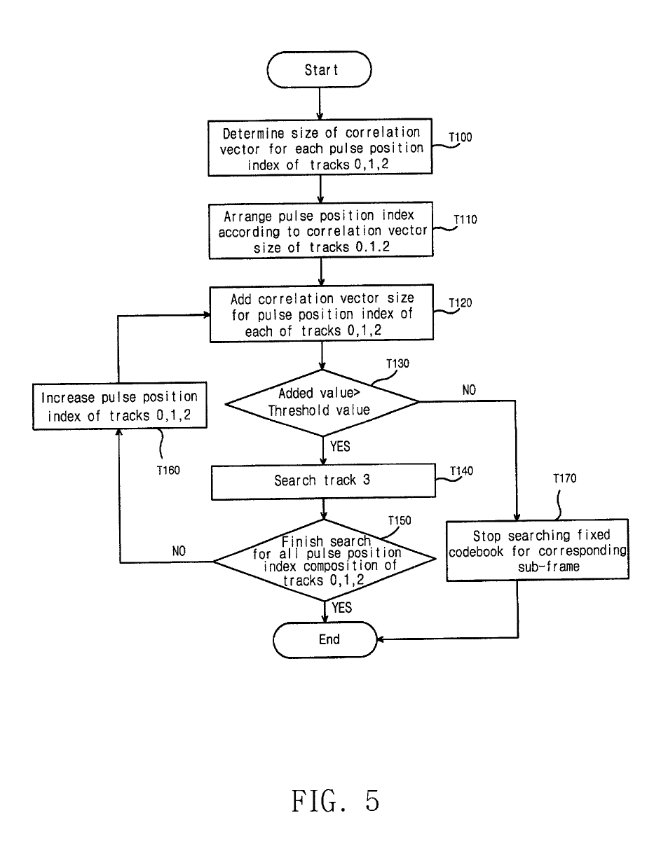

FIG. 5 shows the fixed codebook search method according to the present invention. As shown in the figure, the fixed codebook search method includes the steps of determining a correlation value for each pulse position index of the tracks (t₀, t₁, t₂) T100, arranging the pulse position indexes of the tracks (t₀, t₁, t₂) according to the correlation value of each track T110, calculating sum of the correlation values for each pulse position index of the tracks (t₀, t₁, t₂) T120, checking whether the calculated sum is over the threshold value T130, searching the track 3 (t₃) if the calculated sum is over the threshold value T140, checking whether search for all pulse position index compositions of the tracks (t₀, t₁, t₂) is completed after searching the track 3 (t₃) T150, increasing the pulse position indexes of the tracks (t₀, t₁, t₂) if the search for all pulse position index compositions of the tracks (t₀, t₁, t₂) is not completed T160, and finishing the fixed codebook search for the corresponding sub-frames if the calculated sum is equal to or less than the threshold value T170.

As shown in the Table 3, the tracks (t₀, t₁, t₂) are searched in an order dependent on a size of d′(n). However, all of 8 position values of each track are not searched, but some position values limited depending on probability are searched. For an example based on Table 4, only 4 position values are searched in the track (t₀), only 5 position values are searched in the track (t₁) and only 6 position values are searched in the track (t₂), while the searching process for other position values having low probability is excluded, so reducing computational complex without loss of the tune quality.

Interactions between the steps are described below with reference the Tables 1, 2, 3 and 4.

The step of determining the correlation values for each pulse position index in the tracks (t₀, t₁, t₂) T100 determines the correlation values for each pulse position index in each track. That is, if the correlation value is d′(n), the step T100 determines sized of d′(0), d′(5), d′(10) . . . , d′(35) for the track 0 (t₀), sizes of d′(1), d′(6), d′(11), . . . d′(36) for the track 1 (t₁), and sizes of d′(2), d′(7), d′(12) . . . , d′(37) for the track 2 (t₂).

Table 2 is a chart showing the correlation values for each pulse position index of the tracks (t₀, t₁, t₂) in a specific sub-frame.

The step of arranging the pulse position indexes of the tracks (t₀, t₁, t₂) according to the correlation value of each track T110 is comparing sizes of correlation vectors of each pulse position index for each track and then arranging them in a descending order.

In other word, the step T110 compares the correlation vector sizes obtained for all pulse position indexes of the track 0 (t₀) and then arranges the correlation vectors in a descending order. The step T110 executes arrangement for the tracks 1 and 2 in a descending order by using the same way.

Table 3 is a chart showing the process of arranging the pulse position indexes in a descending order according to the correlation vector sizes of each of the tracks (t₀, t₁, t₂) in a specific sub-frame.

Referring to Tables 2 and 3, Table 2 is assumed that the correlation value is given for each pulse position index and Table 3 shows pulse position indexes arranged in a descending order on the basis of the correlation value.

Therefore, the pulse position indexes are newly arranged in the tracks (t₀, t₁, t₂), in which the pulse position indexes are arranged as 5, 25 . . . , 30 in the track 0, as 6, 1 . . . , 31 in the track 1, and as 32, 37, . . . , 27 in the track 2.

The step T120 calculates a sum of the correlation values for each pulse position index of the tracks (t₀, t₁, t₂).

Referring to Table 3, the step T120 obtains a sum of the correlation values for each pulse position index |d(5|+|d(6)|+|d(32|, for each pulse position index composition (5, 6, 32) of the tracks (t₀, t₁, t₂).

In addition, the step of checking whether the calculated sum is over the threshold value T130 performs comparison between the calculation sum of the pulse position index composition and the threshold value previously determined before the fixed codebook search.

The step T140 searches an optimal pulse position in the track 3 for the pulse position index composition if the calculated sum is over the threshold value.

As an example, if the sum of the correlation vector sizes for the pulse position index composition (5, 6, 32) is bigger than the threshold value in Table 3, the search candidates for searching an optimal pulse position in the tracks 0, 1 and 2 become (5, 6, 32, 3), (5, 6, 32, 8) . . . (5, 6, 32, 39). They are compositions adding each pulse position index of the track 3 shown in FIG. 1 to the pulse position index composition (5, 6, 32).

The step of checking whether search for all pulse position index compositions of the tracks (t₀, t₁, t₂) is completed after searching the track 3 (t₃) T150 is to check whether the track 3 is searched for all candidates in the case that the calculated sum is over the threshold value.

The step of increasing the pulse position indexes of the tracks (t₀, t₁, t₂) if the search for all pulse position index compositions of the tracks (t₀, t₁, t₂) is not completed T160 is increasing the pulse position index to obtain the next pulse position index composition for the tracks 0, 1 and 2 in the case that the calculated sum is over the threshold value.

As an example, if the current search candidate is (5, 6, 32) for the tracks 0, 1 and 2, the next search candidate adding the pulse position index may be (5, 6, 37).

If the pulse position index is added one more time, the next search candidate may be (5, 6, 12).

If the calculated sum is equal to or less than the threshold value, the search for the track 3 is not performed but the fixed codebook search for the corresponding sub-frames is finished T170.

Therefore, if there is a candidate not over the threshold value when determining candidates for searching the track 3, other candidates are also not over the threshold value, so stopping the search for the fixed codebook to reduce unnecessary computational complex.

FIG. 4 is a chart showing statistical probabilities that each pulse position for the tracks 0, 1 and 2 is selected as an optimal pulse position. As shown in the figure, probability values that each pulse position for the tracks 0, 1 and 2 is selected as an optimal pulse position are arranged sequentially. Their arrangement is identical to that which is arranged in a descending order based on the size of the correlation value for each pulse position index.

This will be well understood with reference to the Formula 8, in which the numerator has more attribution than the denominator because the numerator of the Formula 8 based on the d′(n) value is in a square type.

Therefore, the pulse position, which maximizes the correlation value (Ck), is very probable to be the optimal pulse position, while the pulse position having the biggest correlation vector size is most probable to be the optimal pulse position.

According to such method, only limited pulse position values are searched according to the probability, or the size of the correlation value, not searching all of 8 pulse positions of the tracks 0, 1 and 2.

As an example, in Table 4, only 4 pulse positions are searched in the track (t₀), only 5 pulse positions are searched in the track (t₁) and only 6 pulse positions are searched in the track (t₂), while the searching process for other pulse positions having low probability is excluded, so reducing computational complex without loss of the tune quality.

In other word, by using the method of the present invention, better performance is expected in an aspect of the computational complex in the fixed codebook search than the prior art, with same tune quality.

Furthermore, the high-speed fixed codebook search method of the present invention may be applied to the search process for various types of fixed codebook having a logarithmic structure.

TABLE 1

| Track | Pulse | Sign | Pulse Position |
|---|---|---|---|
| t₀ | i₀ | S₀: ± 1 | m₀: 0, 5, 10, 15, 20, 25, 30, 35 |
| t₁ | i₀ | S₁: ± 1 | m₁: 1, 6, 11, 16, 21, 26, 31, 36 |
| t₂ | i₀ | S₂: ± 1 | m₂: 2, 7, 12, 17, 22, 27, 32, 37 |
| t₃ | i₀ | S₃: ± 1 | m₃: 3, 8, 13, 18, 23, 28, 33, 38 |
| | | | 4, 9, 14, 19, 24, 29, 34, 39 |

TABLE 2

| | Correlation Value for each Pulse Position | | | | | | | |
|---|---|---|---|---|---|---|---|---|
| Track | 1 | 2 | 3 | 4 | 5 | 6 | 7 | 8 |
| t₀ | 321.46 | 607.41 | 427.43 | 315.35 | 160.85 | 435.74 | 92.08 | 262.93 |
| t₁ | 394.46 | 707.68 | 163.61 | 68.24 | 273.52 | 146.57 | 57.10 | 250.15 |
| t₂ | 92.74 | 226.62 | 311.25 | 128.03 | 279.58 | 5.06 | 929.33 | 351.56 |

TABLE 3

| Track | Pulse | Sign | Pulse Position |
|---|---|---|---|
| t₀ | i₀ | S₀: ± 1 | m₀: 5, 25, 10, 0, 15, 35, 20, 30 |
| t₁ | i₀ | S₁: ± 1 | m₁: 6, 1, 21, 37, 11, 26, 16, 31 |
| t₂ | i₀ | S₂: ± 1 | m₂: 32, 37, 12, 22, 7, 17, 2, 27 |

TABLE 4

| | Probability for each Pulse Position | | | | | | | |
|---|---|---|---|---|---|---|---|---|
| Track | 1 | 2 | 3 | 4 | 5 | 6 | 7 | 8 |
| t₀ | 0.63194 | 0.19104 | 0.08319 | 0.03751 | 0.02712 | 0.01411 | 0.00773 | 0.00432 |
| t₁ | 0.59331 | 0.20665 | 0.08967 | 0.04761 | 0.02902 | 0.01708 | 0.01142 | 0.00521 |
| t₂ | 0.60419 | 0.19561 | 0.09091 | 0.04770 | 0.02717 | 0.01631 | 0.01162 | 0.00645 |

The present invention gives effects of reducing computational complex required to search the codebook without signal distortion in quantizing the LSP counts of the speech encoder using SVQ manner, and reducing computational complex without loss of tone quality in G .729 fixed codebook search by performing candidate selection and search on the basis of the correlation value size of the pulse position index.

What is claimed is:

1. A high-speed search method in a speech encoder using an order character of LSP (Line Spectrum Pair) counts in a LSP count quantizer using SVQ (Split Vector Quantization) used in a low-speed transmission speech encoder, the high-speed search method comprising the steps of:
rearranging a codebook according to an element value of a reference row for determining a range of code vectors to be searched; and
determining a search range by using an order character between a given target vector and an arranged code vector to obtain an optimal code vector.

2. The high-speed search method as claimed in claim 1, wherein the rearranging step comprises the steps of:
selecting the reference row in each codebook by using a plurality of voice data, and then determining an optimal arrangement position (Nm) in which an average search range is minimized; and
replacing the codebook with a new codebook in which a number (Lm) of code vectors in the codebook are arranged in a descending order according to an element value of the selected reference row.

3. The high-speed search method as claimed in claim 1, wherein the code vector-obtaining step comprises the step of:
determining the search range by forward and backward comparison of the element value of the reference row in the arranged codebook and element values of rows before and after the target vector; and
obtaining an error criterion (E_{1,m}) having high computational complexity by using the below Equation 2 only within the determined search range.

4. The high-speed search method as claimed in claim 3, wherein the search range is an average number with which an element value of the n^{th} row in the arranged codebook and element values in the n+1^{th} and n−1^{th} positions of the target vector satisfy the order character.

5. A high-speed search method in the G.729 fixed codebook with decreased computational complexity without loss of tone quality, the high-speed search method comprising the steps of:
arranging position indexes of tracts (t₀, t₁, t₂) in a descending order according to a correlation level (d′(n));
determining a range to search a tract (t3) according to the indexes arranged in a descending order; and
canceling the detecting and searching processes for indexes which has low probability.

6. The high-speed search method in the G.729 fixed codebook as claimed in claim 5, wherein the arranging step comprises the step of:
comparing correlation vectors of all of the pulse position indexes in each track to arranging the position indexes in a descending order.

7. The high-speed search method in the G.729 fixed codebook as claimed in claim 5, wherein the search range-determining step comprises the steps of:
adding correlation values of each pulse position index for the pulse position index combination of the tracks (t₀, t₁, t₂); and
comparing the added result with a threshold (Cth) determined before the search of the fixed codebook to search track (t3) using an added result more than the threshold.

8. The high-speed search method in the G.729 fixed codebook as claimed in claim 5, wherein the canceling step comprises the step of:
canceling the searching process for the range where the added result is less than the threshold.
